(19) United States
(12) Patent Application Publication
(10) Pub. No.: US 2009/0234533 A1
(43) Pub. Date: Sep. 17, 2009

(54) PROGRAMMED ENGINE OIL CHANGE NOTIFICATION SYSTEM FOR AN ENGINE-DRIVEN WELDER/GENERATOR

(75) Inventor: Mike J. Trinkner, Kaukauna, WI (US)

Correspondence Address: FLETCHER YODER (ILLINOIS TOOL WORKS INC.), P.O. BOX 692289, HOUSTON, TX, 77269-2289, US

(73) Assignee: ILLINOIS TOOL WORKS INC., Glenview, IL (US)

(21) Appl. No.: 12/047,241

(22) Filed: Mar. 12, 2008

(51) Int. Cl. F02D 45/00

(52) U.S. Cl. 701/31; 702/55

(57) ABSTRACT

An engine oil change notification system is disclosed for an engine-driven electrical generator (e.g., welder/generator). The system may include an engine, an electrical generator, and an oil system configured to provide oil for lubrication of the engine. The system may further include a plurality of sensors coupled to the engine, the generator, and the oil system. The plurality of sensors may be configured to detect and measure operating parameters that are indicative of the quality of oil. The system may also include a processor configured to process the signals received from the plurality of sensors. Further, the processor may time stamp the signals and store data in a memory. The memory may include criteria data for determining the quality of the oil. Finally, the system may include a control panel that is coupled to the processor and configured to communicate the quality of the oil.

### BACKGROUND

The invention relates generally to the field of engine-driven electrical generators. More specifically, the invention relates to an engine oil change notification system that may be used in the operation of an engine-driven generator for various torch systems, such as a welding system, a cutting system (e.g., plasma cutting system), or the like.

Portable engine-driven generators (e.g., welder/generators) are commonly used to provide electrical power in locations where conventional electrical power is not readily available. Both gasoline and diesel engines are used to drive such generators, and the power produced is typically either 120 VAC or 240 VAC. Exemplary engine-driven generators include an oil system configured to provide oil for lubrication and operation of the engine. As expected, the lubricious properties of the oil may degrade over time due to a number of different operating parameter and variables (e.g., oil temperature, ambient temperature, engine load, etc.). Unfortunately, current engine-driven generators (e.g., welder/generators) fail to account for important operating parameters in determining when an oil change may or may not be desirable. Instead, oil changes for all units are generally performed according to a pre-set schedule, e.g., after a pre-determined number of operating hours (e.g., 25, 50, 100, etc.). Moreover, the pre-determined number of operating hours may be based on a worst case scenario that may not accurately reflect the quality of the oil in a specific generator (e.g., welder/generator) under actual operating conditions. This can lead to costly maintenance and repair and/or unnecessary oil changes.

### BRIEF DESCRIPTION

Embodiments of the present invention provide an improved engine oil change notification system and method. The disclosed embodiments may include an engine-driven electrical generator having an oil system configured to provide oil for lubrication of the engine. The power generated by the electrical generator may be used for a torch operation (e.g., welding, cutting, or both), and the generator may include one or more power coils for general auxiliary power, welding power, cutting power (e.g., plasma cutting power), and so forth. Additionally, the disclosed embodiments may include a pair of cables for connection to a torch (e.g., a welding gun, a plasma cutting torch, etc.) and a work piece.

The disclosed embodiments may further include a plurality of sensors coupled to the engine, the generator, the oil system, and torch components (e.g., welding components, plasma cutting components, etc.). The plurality of sensors may be configured to measure operating parameters of the engine, the generator, the oil system, welding feedback, plasma cutting feedback, and so forth. For example, the plurality of sensors coupled to the electrical generator may include a voltage sensor, a current sensor, a temperature sensor, or a combination thereof. The plurality of sensors coupled to the oil system may include a temperature sensor configured to measure the temperature of the oil, a pressure sensor configured to measure pressure in the oil system, or a combination thereof. The plurality of sensors coupled to the engine may include a tachometer configured to measure engine speed, a position sensor configured to measure throttle position, or a combination thereof. The plurality of sensors coupled to torch components may include a voltage sensor, a current sensor, a temperature sensor, or a combination thereof. In sum, the sensors are configured to detect and measure operating parameters that may be used to determine the quality of oil for a specific generator under actual operating conditions.

The disclosed embodiments may also incorporate a processor coupled to the plurality of sensors. The processor may be configured to process signals from the sensors to determine a quality of the oil based upon the signal data. Further, the processor may be configured to time stamp the signal data and store the data in a memory coupled to the processor. The memory may include criteria data for determining the quality of the oil. For example, the criteria data may include empirical data, formulas, tables, rules, maps, historical data, or a combination thereof.

Finally, the disclosed embodiments may include a control panel that is coupled to the processor and configured to communicate the quality of the oil to an operator. The control panel may include a display configured to indicate total operating hours since the last oil change, remaining operating hours before the next oil change is due, a qualitative indication of the oil quality, one or more operating parameters measured by the plurality of sensors, an alarm for providing notice to an operator, or a combination thereof. Additionally, the alarm on the control panel may be an audible alarm configured to provide notice to an operator remotely positioned from the generator.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary engine oil change notification system in accordance with embodiments of the invention, illustrating an engine coupled to an electrical generator (e.g., a welder/generator) that includes a processor and a control panel;

FIG. 2 is a diagrammatical representation of an exemplary processor in accordance with embodiments of the invention, illustrating a processor configured to receive signals from a plurality of sensors and process the signals for communication to a control panel; and

FIG. 3 is a flow chart illustrating a method of using one or more of the embodiments of the engine oil change notification system.

### DETAILED DESCRIPTION

Embodiments of the present invention provide an engine oil change notification system and method for use with portable engine-driven generators and various torch systems (e.g., welding, cutting, etc.) having engine-driven generators. For example, specific embodiments incorporate the engine oil notification system into a portable welder-generator system, a portable plasma cutter-generator system, or a combination thereof. As discussed further below, embodiments of the oil change notification system may be used to tailor oil changes to operational conditions of each individual system, rather than using a common schedule for all systems. Thus, embodiments of the system include a plurality of sensors coupled to an engine, an electrical generator, an oil system, and torch system components (e.g., welding components, cutting components, or both). The plurality of sensor may detect and measure a number of operating parameters associated with the engine-driven generator that may be indicative of the oil quality in the oil system. These parameters may include engine feedback, generator feedback, welding system feedback, cutting system feedback, oil system feedback, and the like. The system may further include a processor that is coupled to the plurality of sensor. The processor accesses memory that includes criteria data to enable the processor to determine oil quality based on the compilation of historical and empirical data. In other words, the quality of the oil is determined based on actual operating conditions for a specific system, and is not based on one generic worst case scenario. This avoids unnecessary maintenance and repair costs that may result when the worst case scenario does not accurately reflect the actual operating conditions. Finally, the system includes a control panel that is coupled to the processor to communicate the quality of the oil to an operator.

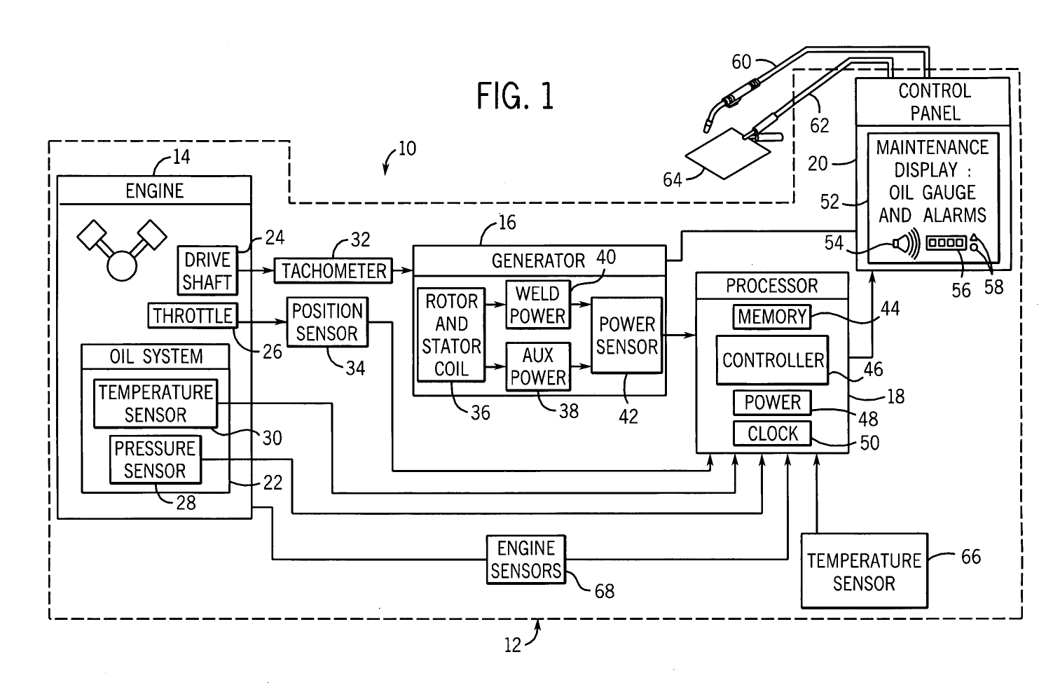

Turning now to the drawings and referring first to FIG. 1, an embodiment of an oil quality system and/or an engine oil change notification system is illustrated and designated generally by reference numeral 10. The illustrated embodiment includes an engine-driven generator-torch system 12, which includes an engine 14, an electrical generator 16, a processor 18, and a control panel 20. The system 12 may include any type of system utilizing generator power. For example, the system 12 may include a welder circuit, a cutting circuit (e.g., a plasma cutting circuit), an induction heating circuit, or a combination thereof. The system 12 may further include an air compressor and/or other components driven by the engine. For purposes of illustration, the system 12 is described below as an engine-driven welder/generator 12. Engine 14 may include a spark-ignition, internal combustion engine (e.g., gasoline engine) or a compression-ignition engine (e.g., diesel engine) having an oil system 22, a drive shaft 24, and a throttle 26. Throttle 26 enables an operator to control the speed of the engine 14 and may include an analog or digital input. Further, drive shaft 24 is coupled to a rotor of generator 16 to enable the conversion of mechanical energy or power, created by engine 14, into electrical energy or power via a rotor/stator system. In some embodiments, a clutch, a belt and pulley system, a gear box, or a combination thereof, may be used to couple the engine 14 to the generator 16, an air compressor, or both.

Oil system 22 provides oil to the engine 14 for lubrication and general operation of engine 14. The oil system 22 may include a plurality of sensors configured to detect and measure operating parameters of the oil system. For example, oil system 22 may include a pressure sensor 28 configured to measure oil pressure and a temperature sensor 30 configured to measure oil temperature. The pressure sensor 28 and temperature sensor 30 may be located in the oil sump or at any other suitable location in the oil system 22. In sum, pressure sensor 28 and temperature sensor 30 measure and detect actual operating parameters of oil system 22 and may be used to determine the quality of the oil in that particular system under those particular operating parameters.

Without the disclosed oil change notification system 10, the oil changes would be based on a single parameter, that is, the total operating time (e.g., hours, days, weeks, months, or the like) of the engine. For example, a typical oil change may occur at about 100 hours or 1 month of operating time, whichever occurs first. This operating time guideline is often based on a worst case scenario as pre-determined via laboratory testing. Further, the worst case scenario is purposely over conservative and may not accurately reflect the quality of the oil in a specific engine-driven welder under actual operating conditions. Therefore, embodiments of the present invention provide the advantage of determining the oil quality based on actual operating conditions of the welder/generator 12, and avoid the generic, over-conservative approach. This is advantageous because it can reduce down time and maintenance cost by foregoing unnecessary oil changes. Moreover, the disclosed embodiments provide an additional level of protection by indicating that an oil change may be desirable when the actual operating conditions exceed those of the worst case scenario.

Similar to oil system 22, drive shaft 24 and throttle 26 may include sensors or transducers for measuring and detecting operating parameters related to these engine components. For example, drive shaft 24 may include a tachometer 32 for measuring the rotations per minutes (rpm) of drive shaft 24 to determine engine speed and/or engine load. Likewise, throttle 26 may include a position sensor 34 to measure throttle position which may also indicate engine speed and/or engine load. Position sensor or transducers 34 may include a potentiometer, linear variable differential transformer (LVDT), proximity sensor, etc.

As discussed above, drive shaft 24 is coupled to generator 16 to generate electrical power. Specifically, drive shaft 24 is coupled to a rotor and stator system 36 of generator 16. The rotor and stator system 36 converts the mechanical energy of drive shaft 24 into electrical energy or electrical power that may be used for a variety of applications. In certain embodiments, the generated power may be used for a welding operation or weld power 40. However, as discussed above, other embodiments may provide welding power, cutting power, or other application-specific power, or a combination thereof. Additionally, the generated power may be used to power other electrical devices and may be referred to as auxiliary power 38. Further, a power sensor 42 may be coupled to weld power 40 and/or auxiliary power 38 to measure the power output of the generator 16. The power output is yet another operating parameter that can determine engine speed and/or engine load. Power sensors 42 may include a number of different sensors or transducers, such as a voltage sensor, a current sensor, or a temperature sensor. Additionally, weld power 40 and auxiliary power 38 may be generated from the same rotor and stator system 36 or may include individual rotor/stator systems, with each system including individual power sensors 42.

All of the signals generated by the plurality of sensors that are coupled to engine 14 and generator 16 may be received by processor 18. Processor 18 may include memory 44, controller 46, power supply 48, and an internal clock 50. As will be discussed below, processor 18 may time stamp the signals received from the plurality of sensors and store them in memory 44. Further, controller 46 may be configured to generate and execute commands to determine the quality of the oil and communicate the results to an operator via control panel 20. Control panel 20 may include a maintenance display 52 that includes an audio alarm 54, meters 56, and/or indicators 58. The maintenance display 52 and alarms 54 will be discussed further below. In general, maintenance display 52 may be configured to indicate the quality of the oil in oil system 22 based, in whole or in part, on actual operating parameters for a specific engine-driven welder 12.

As discussed above, the electrical power generated by generator 16 may be used for a welding operation, a cutting operation, and so forth. For example, torch 60 and ground cable 62 may be coupled to engine-driven welder 12 and used to perform a welding operation on a work piece 64. Engine-driven welder 12 may be configured to perform stick electrode welding, MIG welding, TIG welding, or any other suitable welding operation. Further, the type of welding operation may directly impact the load placed on the engine. Therefore, the type of welding operation implemented is another operating parameter that notification system 10 may take into account to determine the quality of the oil. In other words, certain welding operations and applications inherently demand more power than others and thereby increase or decrease the load placed on engine 14.

Finally, oil change notification system 10 may include a plurality of additional sensors for detecting and measuring other operating parameters and/or loads placed on engine 14. For example, temperature sensor 66 may be included to measure the ambient temperature of the working environment, and may even be configured to record the ambient temperature when engine-driven welder/generator 12 is not operating. This can be advantageous in situations where welder/generator 12 is subjected to extreme environments that affect the temperature and pressure of the oil system regardless of engine operation. In other words, the temperature sensor may be configured to detect and measure changes in the oil system due to ambient temperature changes even though the engine-driven welder/generator 12 is not being used. Moreover, this type of operating parameter is not accounted for by exemplary engine-driven welders that base oil change recommendations strictly on total operating hours. Similarly, additional engine sensors 68 may be included to detect and measure other engine parameters that are indicative of operating conditions or oil degradation. For example, the spark ignition rate may be monitored and used to detect the engine speed and/or engine load.

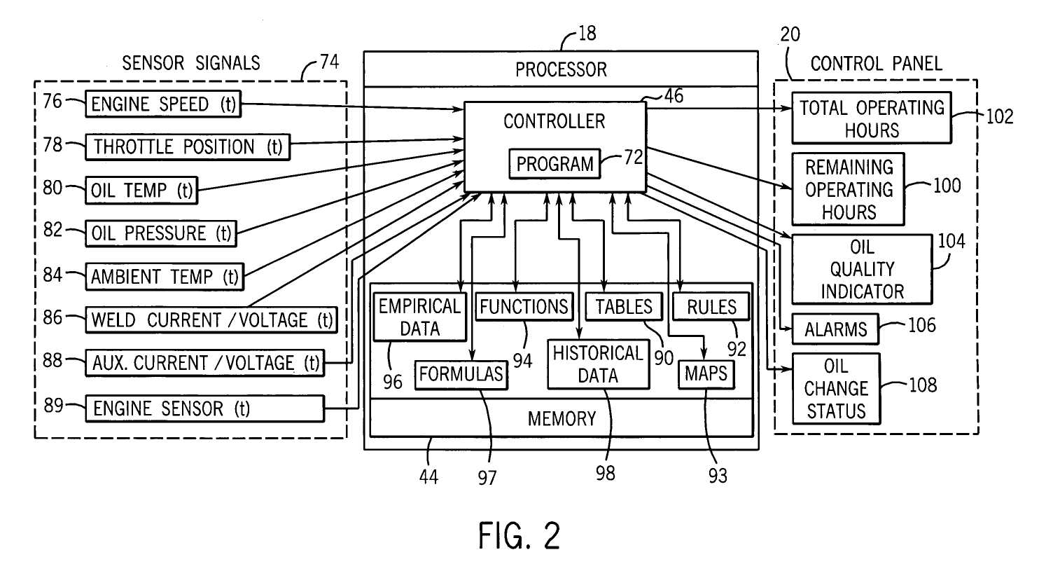

FIG. 2 is a diagrammatical representation of an exemplary processor 18 configured to receive signals from a plurality of sensors and process the signals for communication to an operator via control panel 20. The figure illustrates a program 72 that may be executed by controller 46 and processor 18. Program 72 and controller 46 receive sensor signals 74 that may be a function of time (t). This is advantageous because the time stamped data can account for the duration that the engine and oil system operated under a given operating condition. In other words, each of the measured parameters can create a time history log of the operating conditions that may be directly compared to empirical data. This is important because some parameters may be easier to test in laboratory conditions than others and may not exhibit a linear relationship with oil quality. Therefore, having a complete time history log of each of these parameters enables the system to more accurately determine the oil quality in the system.

Referring to FIGS. 1 and 2, sensor signals 74 may be generated from any of the plurality of sensors coupled to the drive shaft 24, throttle 26, oil system 22, generator 16, and engine 14. For example, tachometer 32 coupled to drive shaft 24 may generate a signal that is indicative of engine speed 76. The engine speed data may be compiled with other sensor data to develop a history of the amount of time an engine operated under a given load. Likewise, position sensor 34 coupled to throttle 26 may generate a signal that is indicative of throttle position 78. Again, throttle position 78 may be further indicative of engine speed or engine load, and may be compared to empirical data to determine the quality of the oil.

Temperature sensor 30 and pressure sensor 28, coupled to oil system 22, may generate signals that are indicative of oil temperature 80 and oil pressure 82, respectively. This information may be compiled with other sensor data to indicate the quality of the oil in the oil system. For example, exemplary embodiments of the present invention are configured to maintain an oil temperature in the range of 150 degrees Celsius. However, a reduction in oil volume may result in an increase in the temperature and/or pressure in the oil system 22 that may not be detected by the other sensors. Therefore, temperature sensor 30 and pressure sensor 28 provide further insight into the quality of the oil in oil system 22.

Further, temperature sensor 66 may generate a signal that is indicative of ambient temperature 84 of the working environment. This may be important when the engine-driven welder 12 is operated in extreme working environments, e.g., low or high temperatures. For example, exemplary embodiment of the present invention are configured to operate in environments having ambient temperatures as low as −28 Celsius or as high as 45 Celsius. Therefore, this ambient temperature data may be complied with the other sensor data to provide another indication of the quality of the oil in oil system 22.

Finally, because engine-driven welders convert mechanical energy into electrical energy, detecting and measuring the electrical power output may be indicative of engine load and used as another indication of the quality of the oil in oil system 22. Therefore, power sensor 42 may detect and measure the current and/or voltage for the weld power 86 and auxiliary power 88. Moreover, these sensors may be easier to implement because they typically are not located on moving parts and/or are not required to measure mechanical motion. Similarly, engine sensors 68 may generate a number of engine signals 89 depending on the type and function of the respective transducer.

Processor 18 and controller 46 may be configured to receive sensor signals 74 for further processing and storage in memory 44. Memory 44 may include criteria data for determining the quality or integrity of the oil located in oil system 22. For example, memory 44 may include tables 90, rules 92, maps 93, functions 94, empirical data 96, formulas 97, historical data 98, or a combination thereof. Tables 90 may include accessible data arrays grouped by operating condition or parameters. For example, tables 90 might include a life cycle analysis of the oil quality as a function of temperature and/or pressure. Specifically, one table or data array may include operating hours based on a fixed pressure with varying temperatures, or vice versa. The tables may be derived from empirical data and may provide for a direct comparison or provide bounds for the processor and program to interpolate between them.

Rules 92 may include logic structure to determine how to interpolate between tables 90 or how to evaluate the compiled data. Rules 92 may further provide the logic structure on how and when to notify an operator that the quality of the oil has degraded to a point that requires an oil change. Further, rules 92 may include threshold indicators that alert controller 46 to disable engine 14 to prevent possible engine damage. For example, a threshold indicator may be one that indicates that the oil is approaching a temperature that may result in complete thermal breakdown of the oil.

Maps 93 may also be included in the criteria data to help determine the quality of the oil in oil system 22. Similar to tables 90, maps 93 may be developed based on empirical data and/or current operating parameters for the given engine-driven welder 12. For example, maps 93 may be used to determine the number of operating hours remaining before an oil change is desirable. Additionally, functions 94 may be generated based on historical data 98 and/or empirical data 96, and may even include input from the operator. For example, an ambient temperature function may take into account the working environment temperature and apply a weighting factor based thereon.

Likewise, empirical data 96 and functions 94 may be used to develop formulas 97 to calculate the number of remaining operating hours before an oil change is recommended. The formulas 97 may be based on extrapolations or approximations of empirical data 96 or historical data 98. Finally, historical data 98 may include actual data from the operation of a specific engine driven welder 12 and/or may include empirical test data developed under controlled conditions. Furthermore, historical data may include operating parameters since the last oil change and/or operating parameter for the entire life of the engine-driven generator. In this sense, the engine oil notification system 10 may provide for a number of “field laboratories” that can accumulate and report on the operating parameters for each unique environment and operating conditions. This might be advantageous in post-failure troubleshooting if an engine should stop functioning because of a failure in the oil system.

In sum, the processor 18 may determine the quality of the oil in oil system 22 via using a program 72 to process the criteria data located in memory 44. This is advantageous over other exemplary engine-driven welders which fail to take into account operating parameters and rely strictly on total operating hours of the engine to determine oil change intervals. In other words, the plurality of sensors provide a plethora of data that may be processed and analyzed to determine the quality of the oil in that specific oil system based on actual operating conditions of that specific engine-driven generator.

Once the quality of the oil is determined, control panel 20 enables processor 18 and controller 46 to communicate the oil quality to the operator via a plurality of indicators. Referring to FIGS. 1 and 2, embodiments of the present invention include internal clock 50 that enables the system 10 to time stamp sensor signals 74 and historical data 98. This further enables control panel 20 to provide the operator with a number of indicators based on temporal calculations. For example, control panel 20 may include an indication of the total operating hours 102 for the oil currently in oil system 22. Likewise, control panel 20 may include an indicator of the remaining operating hours 100 for the oil currently in oil system 22. The remaining operating hours may be calculated based on any of the criteria data located in memory 44. Total operating hours 102 and remaining operating hours 100 may be displayed via a meter 56 located on control panel 20. The meter may be an analog, digital, or any suitable meter that communicates the desired result.

Control panel 20 may also include a qualitative indication of the oil quality 104, alarms 106, and oil change status 108. The oil quality indicator 104 may simply be a scaled indication that goes from an unremarkable or safe indication to an immediate attention or critical indication. Further, alarms 106 may include a visual and or audible alarm. The audible alarm may be configured to provide notice to an operator remotely positioned from the generator. Likewise, oil change status 108 may include a simple on/off indicator (e.g., LED) to communicate to the operator that it is time for an oil change.

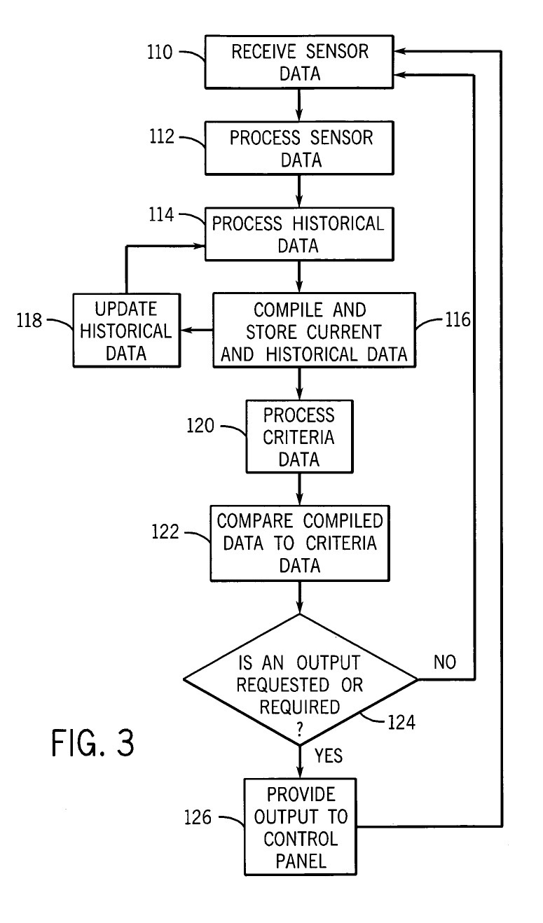

FIG. 3 is a flow chart illustrating a method of using one or more of the embodiments of the engine oil change notification system 10. Specifically, the figure illustrates logic that may be implemented by the processor 18 to determine the quality of the oil in oil system 22. Referring to FIGS. 2 and 3, the process is initiated by processor 18 receiving sensor data 74 from the plurality of sensors (block 110). As discussed, the sensor data may include engine speed 76, throttle position 78, oil temperature 80, oil pressure 82, ambient temperature 84, weld current/voltage 86, auxiliary current/voltage 88, or other sensor data, or a combination thereof.

Processor 18 then processes the sensor data 74 (block 112) and historical data (block 114) to integrate and compile the data (block 116). The complied data may then be stored in memory 44 (block 118) for further processing. Likewise, prior to compiling the data, processor 18 may evaluate the data to detect undesirable operating conditions as determined by rules 92. Next, processor 18 may access and evaluate the criteria data (block 120) as directed by controller 46 and program 72. As discussed, criteria data may include tables 90, rules 92, maps 93, functions 94, empirical data 96, and formulas 97. The criteria data may then be compared to the compiled data (block 122) and a determination of the quality of the oil may be made based on the comparison. Specifically, processor 18 or controller 46 may determine if an output is required or requested via control panel 20 (block 124). If an output is not requested or required, then the process is repeated and processor 18 receives the next packet of sensor data (block 110). If an output is required, processor 18 and controller 46 can display the output to the operator via control panel 20 (block 126). The output may include an indication of the oil quality, any of the measured parameters, an alarm, a message, and so forth. Finally, the decision process (blocks 120 through 126) may run concurrently with the reception process (blocks 110 through 118) in the form of a continuous loop.

Various embodiments of the systems and methods discussed above may include computer code stored on a computer-readable and/or machine-readable media; a controller that may be installed or retrofit into a portable engine-driven generator, welder-generator, or the like; a complete engine-driven system; and so forth. In certain embodiments, a method may include monitoring one or more parameters affecting life of oil in an engine of an engine-driven generator; and processing the one or more parameters to aid in timing of an oil change based on the one or more parameters. Similarly, in some embodiments, a system may include instructions disposed on a machine-readable media, wherein the instructions include instructions for monitoring one or more parameters affecting life of oil in an engine of an engine-driven generator, and instructions for processing the one or more parameters to aid in timing of an oil change based on the one or more parameters. Furthermore, in such a system, the machine-readable media may include memory disposed on a controller of a torch controller (e.g., a welding, cutting, or like controller).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an engine;
an electrical generator driven by the engine; and
an oil quality system configured to evaluate one or more sensed parameters affecting an oil quality of oil in the engine, wherein the oil quality system comprises an indicator configured to notify a user of the oil quality of the oil in the engine.

2. The system of claim 1, wherein the oil quality system is configured to tailor the timing of oil changes in the engine based, at least in part, on the one or more sensed parameters.

3. The system of claim 1, wherein the indicator comprises a display configured to output total operating hours since the last oil change, remaining operating hours for the oil in the system, or a combination thereof.

4. The system of claim 1, wherein the indicator comprises a display configured to output a qualitative indication of the oil quality, the one or more sensed parameters, an alarm configured to notify the user if the oil quality exceeds one or more limits, or a combination thereof.

5. The system of claim 4, wherein the alarm is an audible alarm configured to provide notice to the user when positioned at a remote location relative to the system.

6. The system of claim 1, wherein the oil quality system comprises an oil temperature sensor and a clock configured to measure a first total time of the oil at a temperature, wherein the clock is configured to measure a second total time of operation of the engine.

7. The system of claim 1, wherein the oil quality system comprises an oil temperature sensor, an oil pressure sensor, an oil level sensor, or a combination thereof.

8. The system of claim 1, wherein the oil quality system comprises a tachometer configured to measure engine speed, a position sensor configured to measure throttle position, or a combination thereof.

9. The system of claim 1, wherein the oil quality system comprises a voltage sensor, a current sensor, or a combination thereof.

10. The system of claim 1, wherein the oil quality system is configured to time stamp the one or more sensed parameters.

11. The system of claim 1, comprising a torch circuit coupled to the electrical generator.

12. The system of claim 11, wherein the torch circuit comprises a welding circuit, a cutting circuit, a wire feed circuit, a gas supply circuit, or a combination thereof.

13. The system of claim 12, comprising an air compressor driven by the engine.

14. The system of claim 12, comprising a torch having a cable coupled to the system.

15. The system of claim 1, comprising an induction heating circuit coupled to the electrical generator.

16. A welder-generator system, comprising:
an engine having a lubricant oil;
a generator drivingly coupled to the engine;
a welding circuit coupled to the generator;
one or more sensors configured to monitor parameters of the engine, the generator, the lubricant oil, or a combination thereof;
a controller configured to process data from the one or more sensors and to determine a quality of the oil based, at least in part, on the data, wherein the controller is configured to control at least one feature of the welder-generator system in response to the quality of the oil.

17. The welder-generator system of claim 16, wherein the at least one feature comprises an indicator configured to notify a user of the quality of the oil.

18. The welder-generator system of claim 16, wherein the at least one feature comprises an alarm configured to notify a user that the quality of the oil is beyond one or more limits.

19. The welder-generator system of claim 16, wherein the at least one feature comprises a throttle position of the engine or an on/off state of the engine.

20. The welding-generator system of claim 16, wherein the at least one feature comprises a welding power output from the generator and/or welding circuit to a welding torch.

21. The welder-generator system of claim 16, comprising a display configured to indicate total operating hours since a previous oil change, remaining operating hours for the oil in the engine, a qualitative indication of the quality of the oil, the parameters measured by the one or more sensors, an alarm for providing notice to an operator, or a combination thereof.

22. A method, comprising:
generating electrical power via a generator driven by an engine having an oil system;
measuring operating parameters of the generator, the engine, the oil system, or a combination thereof;
storing data indicative of the operating parameters;
processing the data to evaluate oil quality of oil in the oil system; and
responding to the oil quality by outputting an indication to a user, controlling operation of the engine, controlling operation of the generator, or a combination thereof.

23. A method, comprising:
monitoring one or more parameters affecting life of oil in an engine of an engine-driven generator; and
processing the one or more parameters to aid in timing of an oil change based on the one or more parameters.

24. A system, comprising:
instructions disposed on a machine-readable media, wherein the instructions comprise instructions for monitoring one or more parameters affecting life of oil in an engine of an engine-driven generator, and instructions for processing the one or more parameters to aid in timing of an oil change based on the one or more parameters.

25. The system of claim 24, wherein the machine-readable media comprises memory disposed on a controller of a torch controller.
